(19) United States
(12) Patent Application Publication
(10) Pub. No.: US 2019/0172452 A1
(43) Pub. Date: Jun. 6, 2019

(54) EXTERNAL INFORMATION RENDERING

(71) Applicant: GM GLOBAL TECHNOLOGY OPERATIONS LLC, Detroit, MI (US)

(72) Inventors: Dustin H. Smith, Auburn Hills, MI (US); Gaurav Talwar, Novi, MI (US); Cody R. Hansen, Shelby Township, MI (US); Xu Fang Zhao, LaSalle (CA)

(73) Assignee: GM GLOBAL TECHNOLOGY OPERATIONS LLC, Detroit, MI (US)

(21) Appl. No.: 15/832,950

(22) Filed: Dec. 6, 2017

(51) Int. Cl. G10L 15/22; G10L 15/30

(52) U.S. Cl. CPC G10L 15/22; H04L 67/12; G10L 15/30

(57) ABSTRACT

In various embodiments, methods, systems, and vehicles are provided. The system includes a sensor, a memory, and a processor. The sensor is configured to obtain a request from a user. The memory is configured to store voice assistant data pertaining to respective skills of a plurality of different voice assistants. The processor is configured to at least facilitate: identifying a nature of the request; identifying a selected voice assistant, from the plurality of different voice assistants, having skills that are most appropriate for the request, based on the nature of the request and the voice assistant data; and facilitating communication with the selected voice assistant to provide assistance in accordance with the request.

### TECHNICAL FIELD

The technical field generally relates to the field of vehicles and computer applications for vehicles and other systems and devices and, more specifically, to methods and systems for processing user requests using a voice assistant.

### INTRODUCTION

Many vehicles, smart phones, computers, and/or other systems and devices utilize a voice assistant to provide information or other services in response to a user request. However, in certain circumstances, it may be desirable for improved processing of user requests in certain situations.

Accordingly, it is desirable to provide improved methods and systems for utilize a voice assistant to provide information or other services in response to a request from a user for vehicles and computer applications for vehicles and other systems and devices. Furthermore, other desirable features and characteristics will become apparent from the subsequent detailed description of exemplary embodiments and the appended claims, taken in conjunction with the accompanying drawings.

### SUMMARY

In one embodiment, a method is provided that includes obtaining, via a sensor, a request from a user; identifying, via a processor, a nature of the request; obtaining, via a memory, voice assistant data pertaining to respective skills of a plurality of different voice assistants; identifying a selected voice assistant, from the plurality of different voice assistants, having skills that are most appropriate for the request, based on the nature of the request and the voice assistant data; and facilitating communication with the selected voice assistant to provide assistance in accordance with the request.

Also in one embodiment, the user is disposed within a vehicle; and the processor is disposed within the vehicle, and identifies the nature of the request and the selected voice assistant within the vehicle.

Also in one embodiment, the user is disposed within a vehicle; and the processor is disposed within a remote server that is remote from the vehicle, and identifies the nature of the request and the selected voice assistant from the remote server.

Also in one embodiment, the plurality of different voice assistants are from the group consisting of: a vehicle voice assistant, a navigation voice assistant, a home voice assistant, an audio, a mobile phone voice assistant, a shopping voice assistant, and a web browser voice assistant.

Also in one embodiment, the selected voice assistant includes an automated voice assistant that is part of a computer system.

Also in one embodiment, the selected voice assistant includes a human voice assistant that utilizes information from a computer system.

Also in one embodiment, the method further includes obtaining, via the memory, a user history including previous selections of voice assistants by or for the user; wherein the step of identifying the selected voice assistant includes identifying the selected voice assistant based also at least in part on the user history.

Also in one embodiment, the method further includes updating the user history based on the identification of the selected voice assistant, the providing of assistance by the selected voice assistant, or both.

Also in one embodiment, the method further includes registering the respective skills of the plurality of different voice assistants into the voice assistant data in the memory; and updating the voice assistant data based on the identification of the selected voice assistant, the providing of assistance by the selected voice assistant, or both.

In another embodiment, a system is provided that includes a sensor, a memory, and a processor. The sensor is configured to obtain a request from a user. The memory is configured to store voice assistant data pertaining to respective skills of a plurality of different voice assistants. The processor is configured to at least facilitate: identifying a nature of the request; identifying a selected voice assistant, from the plurality of different voice assistants, having skills that are most appropriate for the request, based on the nature of the request and the voice assistant data; and facilitating communication with the selected voice assistant to provide assistance in accordance with the request.

Also in one embodiment, the user is disposed within a vehicle; and the processor is disposed within the vehicle, and identifies the nature of the request and the selected voice assistant within the vehicle.

Also in one embodiment, the user is disposed within a vehicle; and the processor is disposed within a remote server that is remote from the vehicle, and identifies the nature of the request and the selected voice assistant from the remote server.

Also in one embodiment, the plurality of different voice assistants are from the group consisting of: a vehicle voice assistant, a navigation voice assistant, a home voice assistant, an audio, a mobile phone voice assistant, a shopping voice assistant, and a web browser voice assistant.

Also in one embodiment, the selected voice assistant includes an automated voice assistant that is part of a computer system.

Also in one embodiment, the selected voice assistant includes a human voice assistant that utilizes information from a computer system.

Also in one embodiment, the memory is further configured to store a user history including previous selections of voice assistants by or for the user; and the processor is further configured to at least facilitate identifying the selected voice assistant based also at least in part on the user history.

Also in one embodiment, the processor is further configured to at least facilitate updating the user history based on the identification of the selected voice assistant, the providing of assistance by the selected voice assistant, or both.

Also in one embodiment, the processor is further configured to at least facilitate: registering the respective skills of the plurality of different voice assistants into the voice assistant data in the memory; and updating the voice assistant data based on the identification of the selected voice assistant, the providing of assistance by the selected voice assistant, or both.

In another embodiment, a vehicle is provided that includes a passenger compartment for a user; a sensor; a memory; and a processor. The sensor is configured to obtain a request from the user. The memory is configured to store voice assistant data pertaining to respective skills of a plurality of different voice assistants. The processor configured to at least facilitate: identifying a nature of the request; identifying a selected voice assistant, from the plurality of different voice assistants, having skills that are most appropriate for the request, based on the nature of the request and the voice assistant data; and facilitating communication with the selected voice assistant to provide assistance in accordance with the request.

Also in one embodiment, the plurality of different voice assistants are from the group consisting of: a vehicle voice assistant, a navigation voice assistant, a home voice assistant, an audio, a mobile phone voice assistant, a shopping voice assistant, and a web browser voice assistant.

### DESCRIPTION OF THE DRAWINGS

The present disclosure will hereinafter be described in conjunction with the following drawing figures, wherein like numerals denote like elements, and wherein:

FIG. 1 is a functional block diagram of a system that includes a vehicle, a remote server, various voice assistants, and a control system for utilizing a voice assistant to provide information or other services in response to a request from a user, in accordance with exemplary embodiments; and

FIG. 2 is a flowchart of a process for utilizing a voice assistant to provide information or other services in response to a request from a user, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

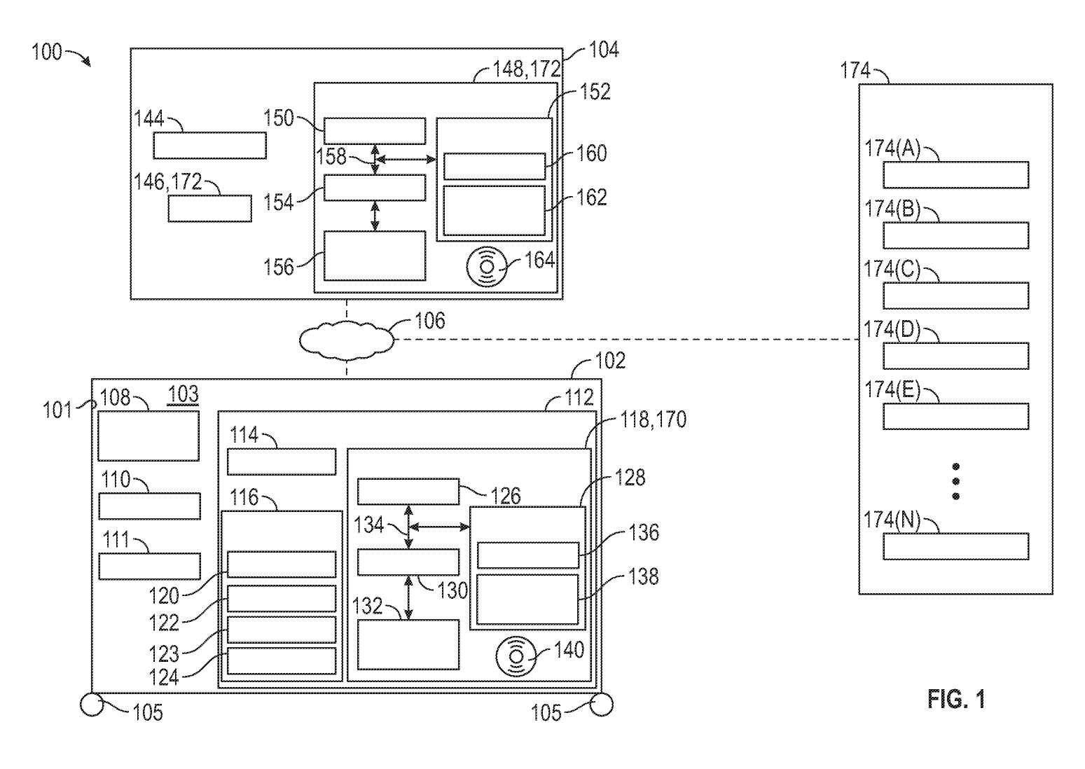

FIG. 1 illustrates a system 100 that includes a vehicle 102, a remote server 104, and various voice assistants 170-174. In various embodiments, As depicted in FIG. 1, the vehicle 102 includes one or more vehicle voice assistants 170, and the remote server 104 includes one or more remote server voice assistants 172. In certain embodiments, the vehicle voice assistant(s) provide information for a user pertaining to one or more systems of the vehicle 102 (e.g., pertaining to operation of vehicle cruise control systems, lights, infotainment systems, climate control systems, and so on). Also in certain embodiments, the remote server voice assistant(s) provide information for a user pertaining to navigation (e.g., pertaining to travel and/or points of interest for the vehicle 102 while travelling).

Also in certain embodiments, various additional voice assistants 174 may comprise any number of other different types of voice assistants 174, such as, by way of example, one or more home voice assistant 174(A) (e.g., pertaining to lighting, climate control, locks, and/or one or more other systems pertaining to a user's home); audio voice assistants 174(B) (e.g., pertaining to music and/or other audio selections, preferences, or instructions for the user); mobile phone voice assistants 174(C) (e.g., pertaining to or utilizing a user's mobile phone and/or services relating thereto); shopping voice assistants 174(D) (e.g., pertaining to a user's preferred shopping website or service); web browser voice assistants 174(E) (e.g., pertaining to a user's preferred web browser and/or search engine for the user's electronic devices); and/or any number of other voice assistants 174(N) (e.g., pertaining to any number of other devices, applications, services, or the like for the user).

It will be appreciated that the number and/or type of voice assistants, including the additional voice assistants 174, may vary in different embodiments (e.g., the use of lettering A . . . N for the additional voice assistants 174 may represent any number of voice assistants). It will similarly be appreciated that in certain embodiments the user may utilize multiple voice assistants of the same or similar types (e.g., certain users may have multiple shopping voice assistants, and so on).

In various embodiments, each of the voice assistants 170-174 is associated with one or more computer systems having a processor and a memory. Also in various embodiments, each of the voice assistants 170-174 may include an automated voice assistant and/or a human voice assistant. In various embodiments, in the case of an automated voice assistant, an associated computer system makes the various determinations and fulfills the user requests on behalf of the automated voice assistant. Also in various embodiments, in the case of a human voice assistant (e.g., a human voice assistant 146 of the remote server 104, as shown in FIG. 1), an associated computer system provides information that may be used by a human in making the various determinations and fulfilling the requests of the user on behalf of the human voice assistant.

As depicted in FIG. 1, in various embodiments, the vehicle 102, the remote server 104, and the various voice assistants 170-174 communicate via one or more communication networks 106 (e.g., one or more cellular, satellite, and/or other wireless networks, in various embodiments). In various embodiments, the system 100 includes one or more voice assistant control systems 119 for utilizing a voice assistant to provide information or other services in response to a request from a user.

As depicted in FIG. 1, in various embodiments the vehicle 102 includes a body 101, a passenger compartment (i.e., cabin) 103 disposed within the body 101, one or more wheels 105, a drive system 108, a display 110, one or more other vehicle systems 111, and a vehicle control system 112. In various embodiments, the vehicle control system 112 of the vehicle 102 comprises or is part of the voice assistant control system 119 for utilizing a voice assistant to provide information or other services in response to a request from a user, in accordance with exemplary embodiments. As depicted in FIG. 1, in various embodiments, the voice assistant control system 119 and/or components thereof may also be part of the remote server 104.

In various embodiments, the vehicle 102 comprises an automobile. The vehicle 102 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the voice assistant control system 119 may be implemented in connection with one or more different types of vehicles, and/or in connection with one or more different types of systems and/or devices, such as computers, tablets, smart phones, and the like and/or software and/or applications therefor, and/or in one or more computer systems of or associated with any of the voice assistants 170-174.

In various embodiments, the drive system 108 is mounted on a chassis (not depicted in FIG. 10, and drives the wheels 109. In various embodiments, the drive system 108 comprises a propulsion system. In certain exemplary embodiments, the drive system 108 comprises an internal combustion engine and/or an electric motor/generator, coupled with a transmission thereof. In certain embodiments, the drive system 108 may vary, and/or two or more drive systems 108 may be used. By way of example, the vehicle 102 may also incorporate any one of, or combination of, a number of different types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

In various embodiments, the display 110 comprises a display screen, speaker, and/or one or more associated apparatus, devices, and/or systems for providing visual and/or audio information, such as map and navigation information, for a user. In various embodiments, the display 110 includes a touch screen. Also in various embodiments, the display 110 comprises and/or is part of and/or coupled to a navigation system for the vehicle 102. Also in various embodiments, the display 110 is positioned at or proximate a front dash of the vehicle 102, for example between front passenger seats of the vehicle 102. In certain embodiments, the display 110 may be part of one or more other devices and/or systems within the vehicle 102. In certain other embodiments, the display 110 may be part of one or more separate devices and/or systems (e.g., separate or different from a vehicle), for example such as a smart phone, computer, table, and/or other device and/or system and/or for other navigation and map-related applications.

Also in various embodiments, the one or more other vehicle systems 111 include one or more systems of the vehicle 102 for which the user may be requesting information or requesting a service (e.g., vehicle cruise control systems, lights, infotainment systems, climate control systems, and so on).

As depicted in FIG. 1, in various embodiments, the vehicle control system 112 includes one or more transceivers 114, sensors 116, and a controller 118. As noted above, in various embodiments, the vehicle control system 112 of the vehicle 102 comprises or is part of the voice assistant control system 119 for utilizing a voice assistant to provide information or other services in response to a request from a user, in accordance with exemplary embodiments. In addition, similar to the discussion above, while in certain embodiments the voice assistant control system 119 (and/or components thereof) is part of the vehicle 102 of FIG. 1, in certain other embodiments the voice assistant control system 119 may be part of the remote server 104 and/or may be part of one or more other separate devices and/or systems (e.g., separate or different from a vehicle and the remote server), for example such as a smart phone, computer, and so on, and/or any of the voice assistants 170-174, and so on.

As depicted in FIG. 1, in various embodiments, the one or more transceivers 114 are used to communicate with the remote server 104 and the voice assistants 172-174. In various embodiments, the one or more transceivers 114 communicate with one or more respective transceivers 144 of the remote server 104, and/or respective transceivers (not depicted) of the additional voice assistants 174, via one or more communication networks 106 of FIG. 1.

Also as depicted in FIG. 1, the sensors 116 include one or more microphones 120, other input sensors 122, cameras 123, and one or more additional sensors 124. In various embodiments, the microphone 120 receives inputs from the user, including a request from the user (e.g., a request from the user for information to be provided and/or for one or more other services to be performed). Also in various embodiments, the other input sensors 122 receive other inputs from the user, for example via a touch screen or keyboard of the display 110 (e.g., as to additional details regarding the request, in certain embodiments). In certain embodiments, one or more cameras 123 are utilized to obtain data and/or information pertaining to point of interests and/or other types of information and/or services of interest to the user, for example by scanning quick response (QR) codes to obtain names and/or other information pertaining to points of interest and/or information and/or services requested by the user (e.g., by scanning coupons for preferred restaurants, stores, and the like, and/or scanning other materials in or around the vehicle 102, and/or intelligently leveraging the cameras 123 in a speech and multi modal interaction dialog), and so on.

In addition, in various embodiments, the additional sensors 124 obtain data pertaining to the drive system 108 (e.g., pertaining to operation thereof) and/or one or more other vehicle systems 111 for which the user may be requesting information or requesting a service (e.g., vehicle cruise control systems, lights, infotainment systems, climate control systems, and so on).

In various embodiments, the controller 118 is coupled to the transceivers 114 and sensors 116. In certain embodiments, the controller 118 is also coupled to the display 110, and/or to the drive system 108 and/or other vehicle systems 111. Also in various embodiments, the controller 118 controls operation of the transceivers and sensors 116, and in certain embodiments also controls, in whole or in part, the drive system 108, the display 110, and/or the other vehicle systems 111.

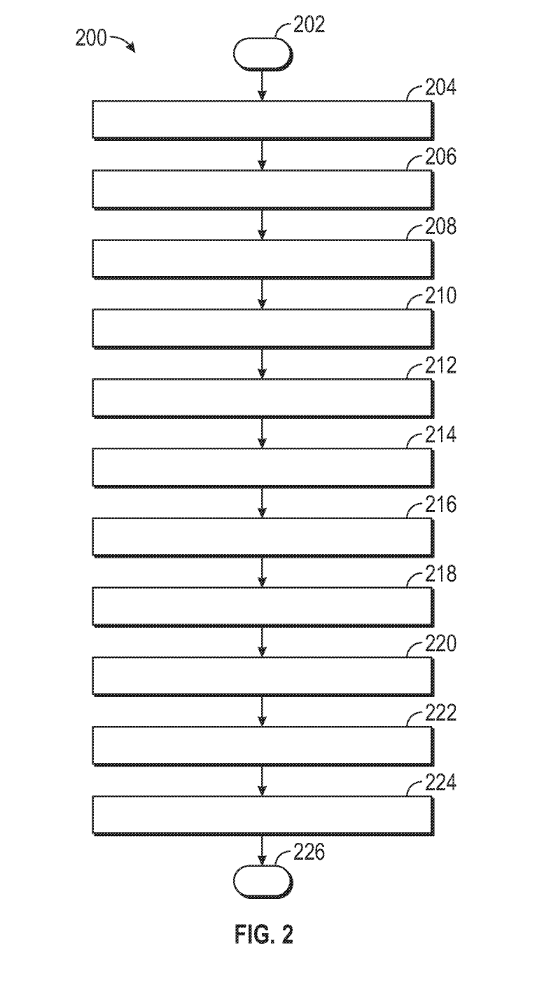

In various embodiments, the controller 118 receives inputs from a user, including a request from the user for information and/or for the providing of one or more other services. Also in various embodiments, the controller 118 determines an appropriate voice assistant (e.g., from the various voice assistants 170-174) to best handle the request, and routes the request to the appropriate voice assistant to fulfill the request. Also in various embodiments, the controller 118 performs these tasks in an automated manner in accordance with the steps of the process 200 described further below in connection with FIG. 2. In certain embodiments, some or all of these tasks may also be performed in whole or in part by one or more other controllers, such as the remote server controller 148 (discussed further below) and/or one or more controllers (not depicted) of the additional voice assistants 174, instead of or in addition to the vehicle controller 118.

As depicted in FIG. 1, the controller 118 comprises a computer system. In certain embodiments, the controller 118 may also include one or more transceivers 114, sensors 116, other vehicle systems and/or devices, and/or components thereof. In addition, it will be appreciated that the controller 118 may otherwise differ from the embodiment depicted in FIG. 1. For example, the controller 118 may be coupled to or may otherwise utilize one or more remote computer systems and/or other control systems, for example as part of one or more of the above-identified vehicle 102 devices and systems, and/or the remote server 104 and/or one or more components thereof, and/or of one or more devices and/or systems of or associated with the additional voice assistants 174.

In the depicted embodiment, the computer system of the controller 118 includes a processor 126, a memory 128, an interface 130, a storage device 132, and a bus 134. The processor 126 performs the computation and control functions of the controller 118, and may comprise any type of processor or multiple processors, single integrated circuits such as a microprocessor, or any suitable number of integrated circuit devices and/or circuit boards working in cooperation to accomplish the functions of a processing unit. During operation, the processor 126 executes one or more programs 136 contained within the memory 128 and, as such, controls the general operation of the controller 118 and the computer system of the controller 118, generally in executing the processes described herein, such as the process 200 described further below in connection with FIG. 2.

The memory 128 can be any type of suitable memory. For example, the memory 128 may include various types of dynamic random access memory (DRAM) such as SDRAM, the various types of static RAM (SRAM), and the various types of non-volatile memory (PROM, EPROM, and flash). In certain examples, the memory 128 is located on and/or co-located on the same computer chip as the processor 126. In the depicted embodiment, the memory 128 stores the above-referenced program 136 along with one or more stored values 138 (e.g., in various embodiments, a database of specific skills associated with each of the different voice assistants 170-174).

The bus 134 serves to transmit programs, data, status and other information or signals between the various components of the computer system of the controller 118. The interface 130 allows communication to the computer system of the controller 118, for example from a system driver and/or another computer system, and can be implemented using any suitable method and apparatus. In one embodiment, the interface 130 obtains the various data from the transceiver 114, sensors 116, drive system 108, display 110, and/or other vehicle systems 111, and the processor 126 provides control for the processing of the user requests based on the data. In various embodiments, the interface 130 can include one or more network interfaces to communicate with other systems or components. The interface 130 may also include one or more network interfaces to communicate with technicians, and/or one or more storage interfaces to connect to storage apparatuses, such as the storage device 132.

The storage device 132 can be any suitable type of storage apparatus, including direct access storage devices such as hard disk drives, flash systems, floppy disk drives and optical disk drives. In one exemplary embodiment, the storage device 132 comprises a program product from which memory 128 can receive a program 136 that executes one or more embodiments of one or more processes of the present disclosure, such as the steps of the process 200 (and any sub-processes thereof) described further below in connection with FIG. 2. In another exemplary embodiment, the program product may be directly stored in and/or otherwise accessed by the memory 128 and/or a disk (e.g., disk 140), such as that referenced below.

The bus 134 can be any suitable physical or logical means of connecting computer systems and components. This includes, but is not limited to, direct hard-wired connections, fiber optics, infrared and wireless bus technologies. During operation, the program 136 is stored in the memory 128 and executed by the processor 126.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 126) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 118 may also otherwise differ from the embodiment depicted in FIG. 1, for example in that the computer system of the controller 118 may be coupled to or may otherwise utilize one or more remote computer systems and/or other control systems.

Also as depicted in FIG. 1, in various embodiments the remote server 104 includes a transceiver 144, one or more human voice assistants 146, and a remote server controller 148. In various embodiments, the transceiver 144 communicates with the vehicle control system 112 via the transceiver 114 thereof, using the one or more communication networks 106.

In addition, as depicted in FIG. 1, in various embodiments the remote server 104 comprises a voice assistant 172 associated with one or more computer systems of the remote server 104 (e.g., controller 148). In certain embodiments, the remote server 104 includes a navigation voice assistant 172 that provides navigation information and services for the user (e.g., information and services regarding restaurants, service stations, tourist destinations, and/or other points of interest for the user that the user may visit during travel by the user). In certain embodiments, the remote server 104 includes an automated voice assistant 172 that provides automated information and services for the user via the controller 148. In certain other embodiments, the remote server 104 includes a human voice assistant 146 that provides information and services for the user via a human being, which also may be facilitated via information and/or determinations provided by the controller 148 coupled to and/or utilized by the human voice assistant 146.

Also in various embodiments, the remote server controller 148 helps to facilitate the processing of the request and the engagement and involvement of the human voice assistant 146, and/or may serve as an automated voice assistant. As used throughout this Application, the term “voice assistant” refers to any number of different types of voice assistants, voice agents, virtual voice assistants, and the like, that provide information to the user upon request. For example, in various embodiments, the remote server controller 148 may comprise, in whole or in part, the voice assistant control system 119 (e.g., either alone or in combination with the vehicle control system 112 and/or similar systems of a user's smart phone, computer, or other electronic device, in certain embodiments). In certain embodiments, the remote server controller 148 may perform some or all of the processing steps discussed below in connection with the controller 118 of the vehicle 102 (either alone or in combination with the controller 118 of the vehicle 102) and/or as discussed in connection with the process 200 of FIG. 2.

In addition, in various embodiments, as depicted in FIG. 1, the remote server controller 148 includes a processor 150, a memory 152 with one or more programs 160 and stored values 162 stored therein, an interface 154, a storage device 156, a bus 158, and/or a disk 164 (and/or other storage apparatus), similar to the controller 118 of the vehicle 102. Also in various embodiments, the processor 150, the memory 152, programs 160, stored values 162, interface 154, storage device 156, bus 158, disk 164, and/or other storage apparatus of the remote server controller 148 are similar in structure and function to the respective processor 126, memory 128, programs 136, stored values 138, interface 130, storage device 132, bus 134, disk 140, and/or other storage apparatus of the controller 118 of the vehicle 102, for example as discussed above.

As noted above, in various embodiments, the various additional voice assistants 174 may comprise any number of other different types of voice assistants 174, such as, by way of example, one or more home voice assistant 174(A) (e.g., pertaining to lighting, climate control, locks, and/or one or more other systems pertaining to a user's home); audio voice assistants 174(B) (e.g., pertaining to music and/or other audio selections, preferences, or instructions for the user); mobile phone voice assistants 174(C) (e.g., pertaining to or utilizing a user's mobile phone and/or services relating thereto); shopping voice assistants 174(D) (e.g., pertaining to a user's preferred shopping website or service); web browser voice assistants 174(E) (e.g., pertaining to a user's preferred web browser and/or search engine for the user's electronic devices); and/or any number of other voice assistants 174(N) (e.g., pertaining to any number of other devices, applications, services, or the like for the user), and so on, and may include automated and/or human voice assistant (e.g., similar to the remote server 104).

It will also be appreciated that in various embodiments each of the additional voice assistants 174 may comprise, be coupled with and/or associated with, and/or may utilize various respective devices and systems similar to those described in connection with the vehicle 102 and the remote server 104, for example including respective transceivers, controllers/computer systems, processors, memory, buses, interfaces, storage devices, programs, stored values, human voice assistant, and so on, with similar structure and/or function to those set forth in the vehicle 102 and/or the remote server 104, in various embodiments. In addition, it will further be appreciated that in certain embodiments such devices and/or systems may comprise, in whole or in part, the voice assistant control system 119 (e.g., either alone or in combination with the vehicle control system 112, the remote server controller 148, and/or similar systems of a user's smart phone, computer, or other electronic device, in certain embodiments), and/or may perform some or all of the processing steps discussed in connection with the controller 118 of the vehicle 102, the remote server controller 148, and/or in connection with the process 200 of FIG. 2.

FIG. 2 is a flowchart of a process for utilizing a voice assistant to provide information or other services in response to a request from a user, in accordance with exemplary embodiments. The process 200 can be implemented in connection with the vehicle 102 and the remote server 104, and various components thereof (including, without limitation, the control systems and controllers and components thereof), in accordance with exemplary embodiments.

As depicted in FIG. 2, the process 200 begins at step 202. In certain embodiments, the process 200 begins when a vehicle drive or ignition cycle begins, for example when a driver approaches or enters the vehicle 102, or when the driver turns on the vehicle and/or an ignition therefor (e.g. by turning a key, engaging a keyfob or start button, and so on). In certain embodiments, the process 200 begins when the vehicle control system 112 (e.g., including the microphone 120 or other input sensors 122 thereof), and/or the control system of a smart phone, computer, and/or other system and/or device, is activated. In certain embodiments, the steps of the process 200 are performed continuously during operation of the vehicle (and/or of the other system and/or device).

In various embodiments, voice assistant data is registered (step 204). In various embodiments, respective skills of the different voice assistants 170-174 are obtained, for example via instructions provided by one or more processors (such as the vehicle processor 126 of FIG. 1, the remote server processor 150 of FIG. 1, and/or one or more other processors associated with any of the voice assistants 170-174 of FIG. 1). Also in various embodiments, the respective skills of the different voice assistants 170-174 are stored as voice assistant data in memory (e.g., as stored values 138 in the vehicle memory 128 of FIG. 1, stored values 162 in the remote server memory 152 of FIG. 1, and/or one or more other memory devices associated with any of the voice assistants 170-174 of FIG. 1).

In addition, in various embodiments, the respective skills for each of the voice assistants 170-174 represent various tasks for which the particular voice assistants 170-174 are adept at providing information and/or services pertaining thereto. For example, in certain embodiments, (i) a vehicle voice assistant may have particular skills pertaining to operating of various vehicle 102 systems (such as one or more engines, entertainment systems, climate control systems, window systems of the vehicle 102, and soon); (ii) a navigation voice assistant may have particular skills pertaining to maps, navigation, driving routes, points of interest while travelling, and so on; (iii) a home voice assistant may have particular skills pertaining to lighting, climate control, locks, and/or one or more other systems pertaining to a user's home; (iv) an audio voice assistant may have particular skills pertaining to music and/or other audio selections, preferences, or instructions for the user; (v) a mobile phone voice assistant may have particular skills pertaining to or utilizing a user's mobile phone and/or services relating thereto; (vi) a shopping voice assistant may have particular skills pertaining to a user's preferred shopping website or service; (vii) a web browser voice assistant 174 may have particular skills pertaining to a user's preferred web browser and/or search engine for the user's electronic devices, and so on.

In various embodiments, user inputs are obtained (step 206). In various embodiments, the user inputs include a user request for information and/or other services. For example, in various embodiments, the user request may pertain to a request for information regarding a particular point of interest (e.g., restaurant, hotel, service station, tourist attraction, and so on), a weather report, a traffic report, to make a telephone call, to send a message, to control one or more vehicle functions, to obtain home-related information or services, to obtain audio-related information or services, to obtain mobile phone-related information or services, to obtain shopping-related information or servicers, to obtain web-browser related information or services, and/or to obtain one or more other types of information or services. Also in various embodiments, the request is obtained automatically via the microphone 120 (e.g., if a spoken request) of FIG. 1. In certain embodiments, the request is obtained automatically via one or more other input sensors 122 of FIG. 1 (e.g., via touch screen, keyboard, or the like).

In certain embodiments, other sensor data is obtained (step 208). For example, in certain embodiments, the additional sensors 124 of FIG. 1 automatically collect data from or pertaining to various vehicle systems for which the user may seek information, or for which the user may wish to control, such as one or more engines, entertainment systems, climate control systems, window systems of the vehicle 102, and so on. Also in certain embodiments, one or more cameras 123 of FIG. 1 automatically obtain additional data, for example pertaining to point of interests and/or other types of information and/or services of interest to the user, for example by scanning quick response (QR) codes to obtain names and/or other information pertaining to points of interest and/or information and/or services requested by the user.

In various embodiments, a user history (or user database) is retrieved (step 210). In various embodiments, the user history includes various types of information pertaining to the user. For example, in certain embodiments, the user database may include a history of past requests for the user, a list of preferences for the user (e.g., points of interest that the user commonly visits, other services often requested by the user, various vehicle and/or non-vehicle systems for which the user has requested information and/or services, and so on), a list of preferred voice assistants that the user prefers using various different types of requests (e.g., a list of subscriptions held by the user, a history of voice assistants that the user has most recently used, has most frequently used, and/or for which the user may have otherwise expressed a preference, and the like), and so on. Also in various embodiments, the user database is stored in the memory 128 of FIG. 1 (and/or the memory 152 of FIG. 1, and/or one or more other memory devices) as stored values thereof, and is automatically retrieved by the processor 126 during step 206 (and/or by the processor 150, and/or one or more other processors). In certain embodiments, the user database includes data and/or information regarding favorites of the user (e.g., favorite points of interest of the user, favorite types of services and/or request made by the user, and so on), for example as tagged and/or otherwise indicated by the user, and/or based on a highest frequency of usage based on the usage history of the user, and so on.

A nature of the user request is identified (step 212). In various embodiments, the nature of the user request of step 206 is automatically determined by the processor 126 of FIG. 1 (and/or by the processor 150 of FIG. 1 and/or one or more other processors) in order to attempt to ascertain the specifics of the user request, including any devices and/or systems (vehicle or non-vehicle) pertaining to the request, and what information and/or services are desired by the user pertaining to such devices and/or systems. For example, in various exemplary embodiment, the processor 126 may seek to determine whether the user is seeking to operate the vehicle climate system or other vehicle system, or seeking directions to a point of interest, or attempting to purchase an item, or attempting to control lighting or other systems of his or her home, or controlling a mobile phone or other device, and so on. In certain embodiments, the processor 126 utilizes automatic voice recognition techniques to automatically interpret the words that were spoken by the user as part of the request, for use in identifying the nature of the request. Also in various embodiments, the processor 126 also utilizes the user history from step 210 in interpreting the request (e.g., in the event that the request has one or more words that are similar to and/or consistent with prior requests from the user as reflected in the user history, and so on).

Also in various embodiments, voice assistant data is obtained with respect to the various voice assistants (step 214). For example, in various embodiments, the particular respective skills of each of the voice assistants 170-174 (e.g., as registered in step 204) are retrieved from memory, in accordance with instructions provided by one or more processors. In certain embodiments, one or more of processors 126, 150 of FIG. 1 (and/or one or more other processors associated with voice assistants 170-174 of FIG. 1) provide instructions to retrieve the voice assistant data including the respective skills from stored values 138 of the vehicle memory 128 of FIG. 1 and/or stored values 162 of the remote server memory 152 of FIG. 1 (and/or one or more other memory devices associated with one or more of the voice assistants 170-174 of FIG. 1).

A determination is made as to which of the various voice assistants is selected as a most appropriate voice assistant for the particular request (step 216). In various embodiments, during step 216, a selected voice assistant of the voice assistants 170-174 of FIG. 1 is determined as having skills that are most appropriate (as compared with the other voice assistants) for the particular request of step 206.

For example, in certain embodiments, when a request to control a particular vehicle system was made by the user, then a vehicle voice assistant 170 may be selected. Also in certain embodiments, when a request for navigation information was made by the user, then a navigation voice assistant 172 may be selected. Similarly, in certain embodiments, when a request for control of a device or system of the user's home was made by the user, then a home voice assistant 174(A) may be selected. Likewise, in certain embodiments, when a request for control of an audio device or audio preferences was made by the user, then an audio voice assistant 174(B) may be selected. By way of additional example, in certain embodiments, when a request for control of a user's mobile phone or associated service was made by the user, then a mobile phone voice assistant 174(C) may be selected. Also in certain embodiments, when a request for shopping information or services was made by the user, then a shopping voice assistant 174(D) may be selected. In addition, in certain embodiments, when a request for control of a user's web browser or associated service was made by the user, then a web browser voice assistant 174(E) may be selected. Furthermore, in certain embodiments, when one or more other types of request are made by the user, one or more other voice assistants 174(N) may be selected, and so on.

In various embodiments, during step 216, the user history of step 210 may also be utilized in identifying the selected voice assistant for the particular user request. For example, in certain embodiments, a voice assistant may be selected based at least in part on the user's preference for a particular voice assistant, such as if the user has frequently and/or most recently used a particular voice assistant for particular types of requests. For example, if the user utilizes multiple shopping voice assistant, then in various embodiments, when the user makes a shopping request, a selection may be made as to a particular shopping voice assistant that the user has used most recently and/or most frequently, and/or for which the user has otherwise expressed a preference (e.g., for which the user has provided positive feedback), and so on.

In addition, in various embodiments, one or more other considerations may also be taken into account when the most appropriate voice assistant is selected. For example, in certain embodiments, if the user is known to have a subscription, contract, and/or other known relationship with a particular voice assistant, then such voice assistant may be selected. Likewise, in certain embodiments, if the vehicle 102, remote server 104, and/or manufacturers and/or partners thereof have a relationship or contract with a particular voice assistant, then such voice assistant may be selected, and so on.

In various embodiments, the most appropriate voice assistant is selected automatically by a processor during step 216. Also in various embodiments, the selection is made by one or more of processors 126, 150 of FIG. 1, and/or one or more other processors associated with voice assistants 170-174 of FIG. 1. In certain embodiments, an automated voice assistant may be selected that is part of a computer system. In certain embodiments, the voice assistants include virtual voice assistants that utilize artificial intelligence associated with one or more computer systems. In certain other embodiments, a human voice assistant may be selected that utilizes information from a computer system in fulfilling the request.

The user's request is then provided to the selected voice assistant (step 218). Specifically, in various embodiments, communication is facilitated between the user and the selected voice assistant of step 216. In certain embodiments, the user's request is forwarded to the selected voice assistant, and the user is placed in direct communication with the selected voice assistant (e.g., via a telephone, videoconference, e-mail, live chat, and/or other communication between the user and the selected voice assistant). In various embodiments, the facilitating of this communication is performed via instructions provided by one or more processors (e.g., by one or more of processors 126, 150 of FIG. 1, and/or one or more other processors associated with voice assistants 170-174 of FIG. 1) via the communication network 106 of FIG. 1.

In various embodiments, the user's request is fulfilled (step 220). In various embodiments, the selected voice assistant provides the requested information and/or services for the user. In addition, in certain embodiments, information and/or details pertaining to the fulfillment of the request are provided (e.g., to one or more of processors 126, 150 of FIG. 1, and/or one or more other processors associated with voice assistants 170-174 of FIG. 1) for use in updating the voice assistant data of step 204 and the user history of step 206.

Also in various embodiments, voice assistant data is updated (step 222). In various embodiments, the voice assistant data of step 204 is updated based on the identification of the selected voice assistant, the providing of assistance by the selected voice assistant, or both. In certain embodiments, user feedback is obtained with respect to the selection of the voice assistant and/or the fulfillment of the request (e.g., as to the user's satisfaction with the selection of the voice assistant and/or the voice assistant's execution in fulfilling the request), and the voice assistant data is updated accordingly based on this feedback. For example, in various embodiments, the voice assistants 170-174 of FIG. 1 may be trained in this manner, for example to learn new skills and/or to have a more accurate description of skills of the various voice assistants. In various embodiments, the voice assistant data is updated in this manner by one or processors (e.g., one or more of processors 126, 150 of FIG. 1, and/or one or more other processors associated with voice assistants 170-174 of FIG. 1), and the respective updated information is stored in memory (e.g., the memory 128, 152 of FIG. 1, and/or one or more other memory devices associated with voice assistants 170-174 of FIG. 1).

Moreover, also in various embodiments, user history data is also updated (step 224). In various embodiments, the user history of step 210 is updated based on the identification of the selected voice assistant, the providing of assistance by the selected voice assistant, or both. Similar to step 222, in certain embodiments, user feedback is obtained with respect to the selection of the voice assistant and/or the fulfillment of the request (e.g., as to the user's satisfaction with the selection of the voice assistant and/or the voice assistant's execution in fulfilling the request), and the user history is updated accordingly based on this feedback. For example, in various embodiments, when a user is satisfied with a particular voice assistant (and/or the selection thereof and/or the voice assistant's fulfillment of the user request), then the user history may be updated accordingly to place a higher likelihood of selecting the same voice assistant in the future (e.g., with respect to similar types of requests), and so on. In various embodiments, the user history is updated in this manner by one or processors (e.g., one or more of processors 126, 150 of FIG. 1, and/or one or more other processors associated with voice assistants 170-174 of FIG. 1), and the respective updated information is stored in memory (e.g., the memory 128, 152 of FIG. 1, and/or one or more other memory devices associated with voice assistants 170-174 of FIG. 1).

In various embodiments, the process 200 then terminates (step 226), for example until the vehicle 102 is re-started and/or until another request is made by the user.

Similar to the discussion above, in various embodiments some or all of the steps (or portions thereof) of the process 200 may be performed by the vehicle control system 112, the remote server controller 148, and/or one or more other control systems and/or controllers of or associated with the voice assistants 170-174 of FIG. 1. Similarly, it will also be appreciated that various steps of the process 200 may be performed by, on, or within a vehicle and/or remote server, and/or by one or more other computer systems, such as those for a user's smart phone, computer, tablet, or the like. It will similarly be appreciated that the systems and/or components of system 100 of FIG. 1 may vary in other embodiments, and that the steps of the process 200 of FIG. 2 may also vary (and/or be performed in a different order) from that depicted in FIG. 2 and/or as discussed above in connection therewith.

Accordingly, the systems, vehicles, and methods described herein provide for potentially improved processing of user request, for example for a user of a vehicle. Based on an identification of the nature of the user request and a comparison with various respective skills of a plurality of different types of voice assistants, the user's request is routed to the most appropriate voice assistant.

The systems, vehicles, and methods thus provide for a potentially improved and/or efficient experience for the user in having his or her requests processed by the most accurate and/or efficient voice assistant tailored to the specific user request. As noted above, in certain embodiments, the techniques described above may be utilized in a vehicle. Also as noted above, in certain other embodiments, the techniques described above may also be utilized in connection with the user's smart phones, tablets, computers, other electronic devices and systems.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method comprising:
obtaining, via a sensor, a request from a user;
identifying, via a processor, a nature of the request;
obtaining, via a memory, voice assistant data pertaining to respective skills of a plurality of different voice assistants;
identifying a selected voice assistant, from the plurality of different voice assistants, having skills that are most appropriate for the request, based on the nature of the request and the voice assistant data; and
facilitating communication with the selected voice assistant to provide assistance in accordance with the request.

2. The method of claim 1, wherein:
the user is disposed within a vehicle; and
the processor is disposed within the vehicle, and identifies the nature of the request and the selected voice assistant within the vehicle.

3. The method of claim 1, wherein:
the user is disposed within a vehicle; and
the processor is disposed within a remote server that is remote from the vehicle, and identifies the nature of the request and the selected voice assistant from the remote server.

4. The method of claim 1, wherein the plurality of different voice assistants are from the group consisting of: a vehicle voice assistant, a navigation voice assistant, a home voice assistant, an audio, a mobile phone voice assistant, a shopping voice assistant, and a web browser voice assistant.

5. The method of claim 1, wherein the selected voice assistant comprises an automated voice assistant that is part of a computer system.

6. The method of claim 1, wherein the selected voice assistant comprises a human voice assistant that utilizes information from a computer system.

7. The method of claim 1, further comprising:
obtaining, via the memory, a user history comprising previous selections of voice assistants by or for the user;
wherein the step of identifying the selected voice assistant comprises identifying the selected voice assistant based also at least in part on the user history.

8. The method of claim 7, further comprising:
updating the user history based on the identification of the selected voice assistant, the providing of assistance by the selected voice assistant, or both.

9. The method of claim 1, further comprising:
registering the respective skills of the plurality of different voice assistants into the voice assistant data in the memory; and
updating the voice assistant data based on the identification of the selected voice assistant, the providing of assistance by the selected voice assistant, or both.

10. A system comprising:
a sensor configured to obtain a request from a user;
a memory configured to store voice assistant data pertaining to respective skills of a plurality of different voice assistants; and
a processor configured to at least facilitate:
identifying a nature of the request;
identifying a selected voice assistant, from the plurality of different voice assistants, having skills that are most appropriate for the request, based on the nature of the request and the voice assistant data; and
facilitating communication with the selected voice assistant to provide assistance in accordance with the request.

11. The system of claim 10, wherein:
the user is disposed within a vehicle; and
the processor is disposed within the vehicle, and identifies the nature of the request and the selected voice assistant within the vehicle.

12. The system of claim 10, wherein:
the user is disposed within a vehicle; and
the processor is disposed within a remote server that is remote from the vehicle, and identifies the nature of the request and the selected voice assistant from the remote server.

13. The system of claim 10, wherein the plurality of different voice assistants are from the group consisting of: a vehicle voice assistant, a navigation voice assistant, a home voice assistant, an audio, a mobile phone voice assistant, a shopping voice assistant, and a web browser voice assistant.

14. The system of claim 10, wherein the selected voice assistant comprises an automated voice assistant that is part of a computer system.

15. The system of claim 10, wherein the selected voice assistant comprises a human voice assistant that utilizes information from a computer system.

16. The system of claim 10, wherein:
the memory is further configured to store a user history comprising previous selections of voice assistants by or for the user; and
the processor is further configured to at least facilitate identifying the selected voice assistant based also at least in part on the user history.

17. The system of claim 16, wherein the processor is further configured to at least facilitate updating the user history based on the identification of the selected voice assistant, the providing of assistance by the selected voice assistant, or both.

18. The system of claim 10, wherein the processor is further configured to at least facilitate:
registering the respective skills of the plurality of different voice assistants into the voice assistant data in the memory; and
updating the voice assistant data based on the identification of the selected voice assistant, the providing of assistance by the selected voice assistant, or both.

19. A vehicle comprising:
a passenger compartment for a user;
a sensor configured to obtain a request from the user; and
a memory configured to store voice assistant data pertaining to respective skills of a plurality of different voice assistants; and
a processor configured to at least facilitate:
identifying a nature of the request;
identifying a selected voice assistant, from the plurality of different voice assistants, having skills that are most appropriate for the request, based on the nature of the request and the voice assistant data; and
facilitating communication with the selected voice assistant to provide assistance in accordance with the request.

20. The vehicle of claim 19, wherein the plurality of different voice assistants are from the group consisting of: a vehicle voice assistant, a navigation voice assistant, a home voice assistant, an audio, a mobile phone voice assistant, a shopping voice assistant, and a web browser voice assistant.
